(19) United States
(12) Patent Application Publication
(10) Pub. No.: US 2026/0177673 A1
(43) Pub. Date: Jun. 25, 2026

(54) LIDAR RECEIVER WITH AN ACTIVE NON-INVERTING DIFFERENTIATOR

(71) Applicant: Y.E. Hub Armenia LLC, Yerevan (AM)

(72) Inventor: Dmitry KOROTEEV, Moscow (RU)

(21) Appl. No.: 19/258,106

(22) Filed: Jul. 2, 2025

(30) Foreign Application Priority Data
Dec. 25, 2024 (RU) 2024139444

(51) Int. Cl. G01S 7/4861; G01S 7/487

(52) U.S. Cl. CPC G01S 7/4861; G01S 7/487

(57) ABSTRACT

A receiver of a light detection and ranging system includes at least one silicon photomultiplier (SiPM) sensor. A SiPM output signal of the at least one SiPM sensor is processed by an active non-inverting differentiator. The differentiator outputs an output signal which is based at least in part on the SiPM output signal, and a signal-to-nose ration (SNR) of the output signal is equal to or greater than the SNR of the SiPM output signal as the differentiator is configured to differentiate in a portion of a frequency domain of the SiPM output signal. The input of the differentiator is an input with active input impedance.

### CROSS-REFERENCE

The present application claims priority to Russian Patent Application No. 2024139444, entitled “Lidar Receiver with an Active Non-Inverting Differentiator”, filed Dec. 25, 2024, the entirety of which is incorporated herein by reference.

### TECHNICAL FIELD

The present technology generally pertains to systems, devices, and methods supporting LIDAR sensing and, in particular, to a LIDAR receiver employing active non-inverting differentiators to process output signals of silicon photomultiplier sensors, and to a method of its operation.

### BACKGROUND

A light detection and ranging (LIDAR) system is a system that scans space using light beams. FIG. 1 illustrates a block diagram of a LIDAR system in accordance with some non-limiting embodiments. LIDAR 100 consists of emitter 110 and receiver 120 of light pulses. Emitter 110 includes light source 112 (for example, a laser). Light source 112 emits short light pulses to surrounding object 140. Receiver 120 receives reflected light signal 142. By knowing the speed of light and determining the response time of light signals from objects, LIDAR can determine the distance to the object.

A number of features should be considered when designing lidars. Short laser pulses are required to measure with high accuracy a distance (a range) to an object using the time-of-flight method (that is, when the laser emits, and the receiver receives without additional calculations). Therefore, it is necessary to concentrate energy as much as possible at the initial stage in order to measure the range more accurately.

LIDAR systems may use various emitters, scanners and photodetectors (receiving units). For example, emitter 110 besides light source 112 also includes scanner 111, and driver 113. Receiver 120 includes optical components 121, light detector 122, and electronic device 123. Electronic device 123 is configured to receive and process signals from light detector 122. Signal processing may include amplifying, attenuating, differentiating, filtering, comparing, storing, or otherwise handling electric signals. For these purposes, electronic device 123 may comprise an application-specific circuit. Electronics device 123 may be controlled by controlling device 130 which may include a processor. Controlling device 130 may also control driver 113 for light source 112 and scanner 111. Light detector 122 may include a photomultiplier tube (PMT) or an avalanche photodiode (APD). However, a PMT integration into a multichannel LIDAR system may be difficult. Light detector 122 may include a silicon photomultiplier (SiPM). SiPMs have become available in the last 10 years. A SiPM sensor may register multiphoton light pulses with a resolution at the level of individual photons. Other advantages of the SiPM sensors are: low operating voltage, low sensitivity to external electro-magnetic fields, slightly variable response, linear with respect to the number of registered photons, and high time resolution.

FIG. 2 shows a table comparing parameters of PMT, APD, and SiPM sensors. Compared to conventional PMTs and APDs, the photoelectron gain in SiPMs is typically more deterministic, resulting in low or even negligible excess noise factor. As a result, the signal-to-noise ratio (SNR) for a fixed number of detected photons can be higher than that from PMT and APD. That is why SiPM may be an attractive choice when designing a LIDAR system. However, SiPM sensors may have a long relaxation time. To use a SiPM sensor, one need to optimize a circuit for the SiPM output signal processing.

Therefore, improvements in systems, devices, and methods to support processing of output signals of photodiode sensors for LIDAR sensing are desirable.

US Patent Application Publication 2024/0142584 A1 discloses a LIDAR detection system with a detector configured to provide a received signal and a processing circuit configured to provide a plurality of quantized signals. The detector may include at least one of a PIN photo diode, an avalanche photo diode (APD), a single photo avalanche diode, or a silicon photomultiplier. The at least one photo diode is configured to generate an analog signal which (e.g., a photo current) in response to a light signal impinging onto the at least one photo diode. The analog signal may be differentiated.

### SUMMARY

The present disclosure relates to systems, devices, and methods supporting photodiode sensors output signals processing. According to embodiments of the present disclosure, there is provided a light detection and ranging (LIDAR) system. The LIDAR system includes an emitting unit, the emitting unit is configured to emit a light onto surrounding objects, and a receiving unit, the receiving unit is configured to detect a portion of the light reflected from the surrounding objects. In some embodiments the receiving unit includes at least one silicon photomultiplier (SiPM) sensor, and a differentiator, wherein an output of the at least one SiPM sensor communicatively coupled to an input of the differentiator.

In some embodiments of the LIDAR system, the differentiator includes an operational amplifier, a capacitor, first and second terminals of the capacitor are connected to an inverting input of the operational amplifier and a ground terminal of the differentiator respectively. The differentiator further includes five resistors: first and second terminals of the first resistor are connected to an input of the differentiator and the inverting input of the operational amplifier respectively; first and second terminals of the second resistor are connected to the inverting input of the operational amplifier and an output of the operational amplifier respectively; first and second terminals of the third resistor are connected to the input of the differentiator and a non-inverting input of the operational amplifier respectively; first and second terminals of the fourth resistor are connected to the non-inverting input of the operational amplifier and the ground terminal of the differentiator respectively; first and second terminals of the fifth resistor are connected to the inverting input of the operational amplifier and the ground terminal of the differentiator respectively. The output of the differentiator is connected to the output of the operational amplifier. In some embodiments of the LIDAR system, the differentiator is configured to output an output signal, the output signal is based at least in part on an input signal, a signal-to-nose ration (SNR) of the output signal is equal to or greater than the SNR of an input signal, and the input signal is inputted to the input of the differentiator by the at least one SiPM sensor.

In some embodiments of LIDAR system, the differentiator is configured to differentiate in a portion of a frequency domain of the input signal thereby increasing the SNR of the output signal in comparison to the SNR of the input signal. In some embodiments, the differentiator is a differentiator with pole compensation. In some other embodiments, the differentiator is an active non-inverting differentiator. In some embodiments, the active non-inverting differentiator is an active non-inverting differentiator with pole compensation. And in some other embodiments of LIDAR system, the input of the differentiator being an input with an active input impedance. In some embodiments, the output of the differentiator is connected to an input of an amplifier or the differentiator is configured to operate as the amplifier.

Some embodiments of the present disclosure are directed to a differentiator device of a light detection and ranging system. The differentiator device comprises: an operational amplifier; a capacitor, first and second terminals of the capacitor are connected to an inverting input of the operational amplifier and a ground terminal of the differentiator device respectively; first resistor, first and second terminals of the first resistor are connected to an input of the differentiator device and the inverting input of the operational amplifier respectively; second resistor, first and second terminals of the second resistor are connected to the inverting input of the operational amplifier and an output of the operational amplifier respectively; third resistor, first and second terminals of the third resistor are connected to the input of the differentiator device and a non-inverting input of the operational amplifier respectively; fourth resistor, first and second terminals of the fourth resistor are connected to the non-inverting input of the operational amplifier and the ground terminal of the differentiator device respectively; and fifth resistor, first and second terminals of the fifth resistor are connected to the inverting input of the operational amplifier and the ground terminal of the differentiator device respectively. The differentiator device further comprises an output of the differentiator device, the output of the differentiator device is connected to the output of the operational amplifier. In some embodiments of differentiator device, the differentiator device is configured to output an output signal, the output signal is based at least in part on an input signal, and a signal-to-nose ration (SNR) of the output signal is equal to or greater than the SNR of an input signal.

In some embodiments, an output of at least one silicon photo multiplier (SiPM) sensor is communicatively coupled to an input of the differentiator, and the input signal is inputted to the input of the differentiator by the at least one SiPM sensor. In some other embodiments, the differentiator device is configured to differentiate in a portion of a frequency domain of the input signal thereby increasing the SNR of the output signal in comparison to the SNR of the input signal. In some embodiments, the differentiator device is an active non-inverting differentiator, in some other embodiments the differentiator device is a differentiator with pole compensation.

In some embodiments of the differentiator device, the differentiator is an active non-inverting differentiator with pole compensation. In some embodiments, the input of the differentiator device is an input with an active input impedance. In some other embodiments, the output of the differentiator device is connected to an input of an amplifier or the differentiator device is configured to operate as the amplifier.

Some embodiments of the present disclosure are directed to a method to operate a light detection and ranging (LIDAR) system. The light detection and ranging system comprises an emitting unit, and a receiving unit. The receiving unit includes at least one silicon photomultiplier (SiPM) sensor, and a differentiator, where an output of the at least one SiPM sensor communicatively coupled to an input of the differentiator.

The differentiator of the receiving unit includes: an operational amplifier; a capacitor; and five resistors. First and second terminals of the capacitor are connected to an inverting input of the operational amplifier and a ground terminal of the differentiator respectively. First and second terminals of the first resistor are connected to the input of the differentiator and the inverting input of the operational amplifier respectively. First and second terminals of the second resistor are connected to the inverting input of the operational amplifier and an output of the operational amplifier respectively. First and second terminals of the third resistor are connected to the input of the differentiator and a non-inverting input of the operational amplifier respectively. First and second terminals of the fourth resistor are connected to the non-inverting input of the operational amplifier and the ground terminal of the differentiator respectively. First and second terminals of the fifth resistor are connected to the inverting input of the operational amplifier and the ground terminal of the differentiator respectively. The output of the operational amplifier of the differentiator is connected to an output of the differentiator.

The method comprises, by the emitter unit: emitting a light onto surrounding objects. The method further comprises, by the receiving unit, capturing by the at least one SiPM sensor a portion of the light reflected from the surrounding objects, generating a SiPM output signal, where the SiPM output signal is based on an output of the at least one SiPM sensor, inputting the SiPM output signal to the input of the differentiator, and operating the differentiator to output an output signal. The output signal is based on the SiPM output signal, and a signal-to-nose ration (SNR) of the output signal is equal to or greater than a SNR of the SiPM output signal.

In some embodiments of the method, the differentiator is configured to differentiate in a portion of a frequency domain of the SiPM output signal thereby increasing the SNR of the output signal in comparison to the SNR of the SiPM output signal. In some other embodiments of the method, the output of the differentiator is connected to an input of an amplifier or the differentiator device is configured to operate as the amplifier. In some embodiments of the method, the differentiator is a differentiator with pole compensation. In some other embodiments of the method, the input of the differentiator is an input with an active input impedance.

For purposes of this application, the terms “differential”, “differentiate”, and “differentiated” may be used herein as commonly understood in their mathematical sense, to indicate an operation in which a derivative of a function is determined. The terms “differential”, “differentiate”, and “differentiated” may be used herein in relation to the processing of a signal to indicate an operation in which variations in the signal level of the signal (e.g., in its amplitude) over time are determined, e.g. an operation in which variations in the slope of the signal over time are determined.

The embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a block diagram of a LIDAR system in accordance with some non-limiting embodiments.

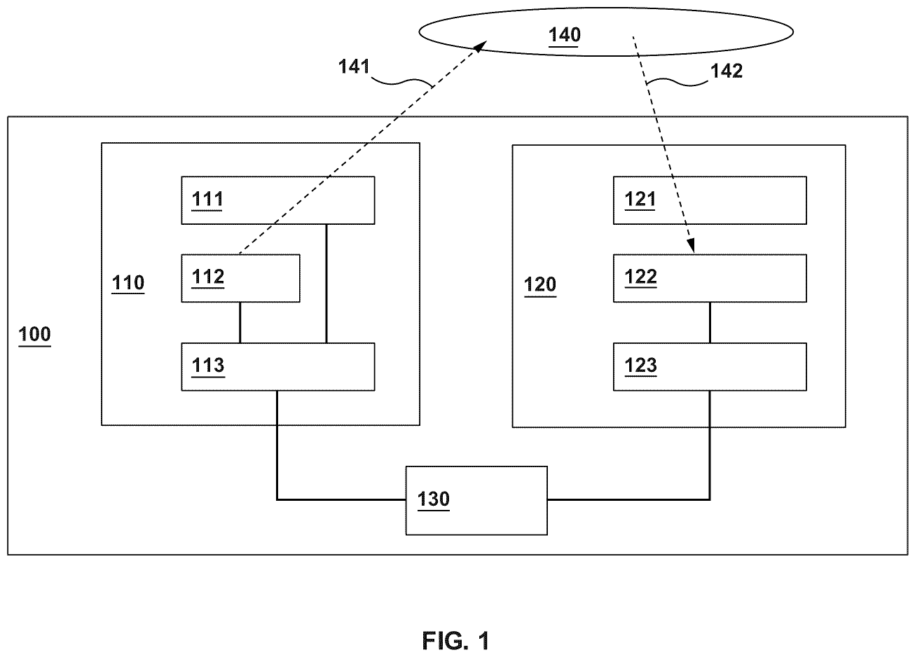

FIG. 2 illustrates parameters of PMT, APD, and SiPM sensors.

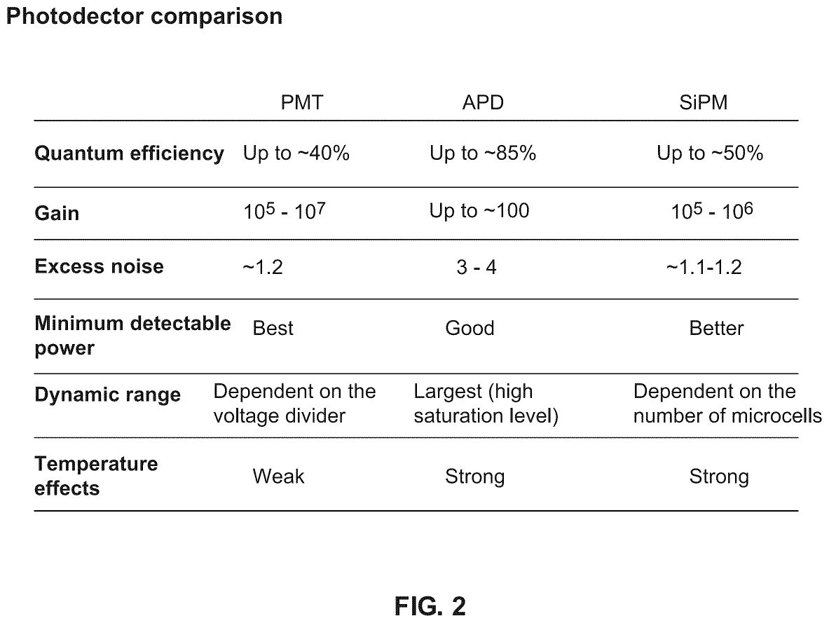

FIG. 3 illustrates an example of a SiPM sensor output signal.

FIG. 4 illustrates a circuit of a passive analog differentiator in accordance with some non-limiting embodiments.

FIG. 5 illustrates a circuit of a passive analog differentiator with pole compensation in accordance with some non-limiting embodiments.

FIG. 6 illustrates the frequency response of the passive analog differentiator without and with pole compensation.

FIG. 7 illustrates a circuit of an active inverting differentiator.

FIG. 8 illustrates a circuit of active non-inverting differentiator according to some non-limiting embodiments of the present technology.

FIG. 9 illustrates a circuit of an active non-inverting differentiator with pole compensation according to some non-limiting embodiments of the present technology.

FIG. 10 illustrates the frequency response of the active non-inverting differentiator without and with pole compensation.

FIG. 11 illustrates the output signals of the active non-inverting differentiator without and with pole compensation in a time domain.

FIG. 12 illustrates a representative example of a LIDAR receiver circuit according to some non-limiting embodiments.

FIG. 13 illustrates a flowchart of a method to operate a LIDAR system.

### DETAILED DESCRIPTION

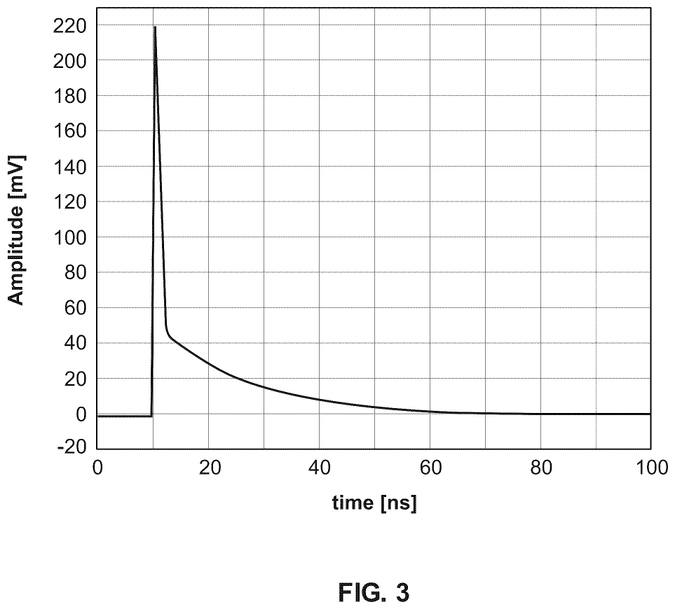

FIG. 3 illustrates an example of a SiPM sensor output signal. The SiPM output signal has a long relaxation time (shown as a tail after the peak on the graph). Signal processing to increase the SNR of the output signal may be required for the SiPM sensor application in the LIDAR system: one needs to receive a response in the high frequency domain to register fast processes and filter out slow ones. Signal processing boosting the SNR of the SiPM output signal may help to increase the effective range of the LIDAR system.

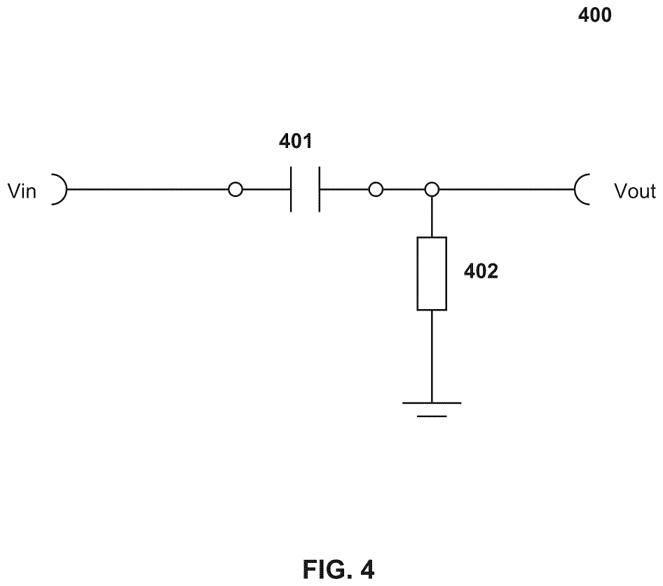

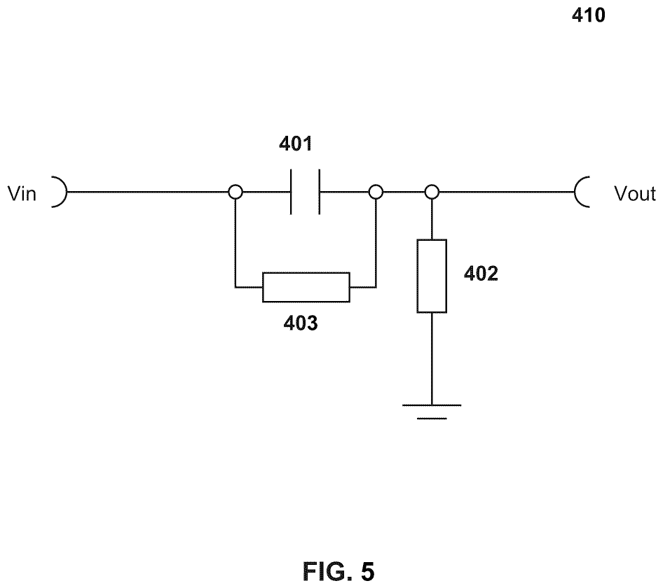

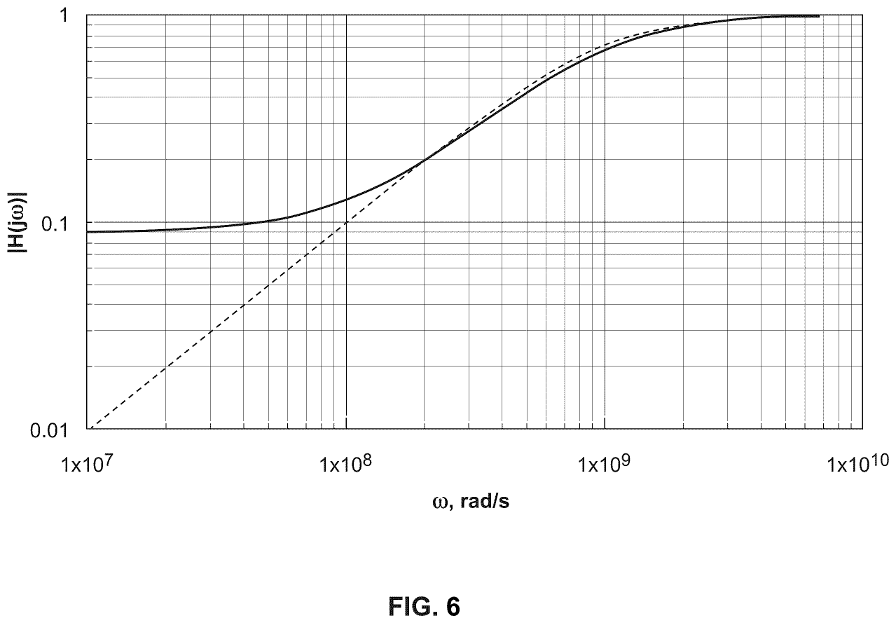

FIG. 4 illustrates a circuit of passive analog differentiator 400 in accordance with some non-limiting embodiments. The circuit includes capacitor 401 and resistor 402. Differentiator 400 allows to register small signals in spite of the background of a prolonged recession. This circuit solution may allow to increase the SNR. It may be advantageous for the purposes of signal registration to differentiate in the high frequency range. However, a smooth decline portion of the SiPM output signal, as shown in FIG. 3, may be of little use. FIG. 5 illustrates a circuit of passive analog differentiator with pole compensation 410. By adding resistor 403 in parallel to capacitor 401, the pole compensation may be achieved in a low frequency portion of the spectrum. FIG. 6 illustrates the frequency response (the dashed line) of passive analog differentiator 400 and the frequency response (the solid line) of the passive analog differentiator with pole compensation 410. Passive differentiator 410 is a passive circuit containing only resistors and the capacitor. In such a circuit, the input and the output resistances are frequency dependent. Furthermore, in such a circuit differentiation occurs only on an inclined part of the amplitude-frequency response (in the high frequency region).

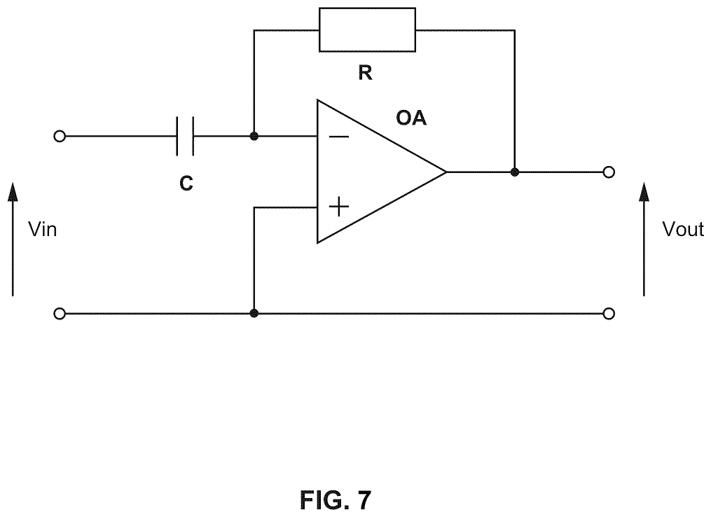

FIG. 7 illustrates a circuit of an active differentiator based on an operational amplifier (OA). This differentiator is able to differentiate at very high frequencies. However, this is an inverting differentiator, the circuit changes the input signal phase by 180 degrees. In addition, the input impedance of this circuit is frequency dependent. Application of an inverting differentiator in a LIDAR system may requires additional circuit changes.

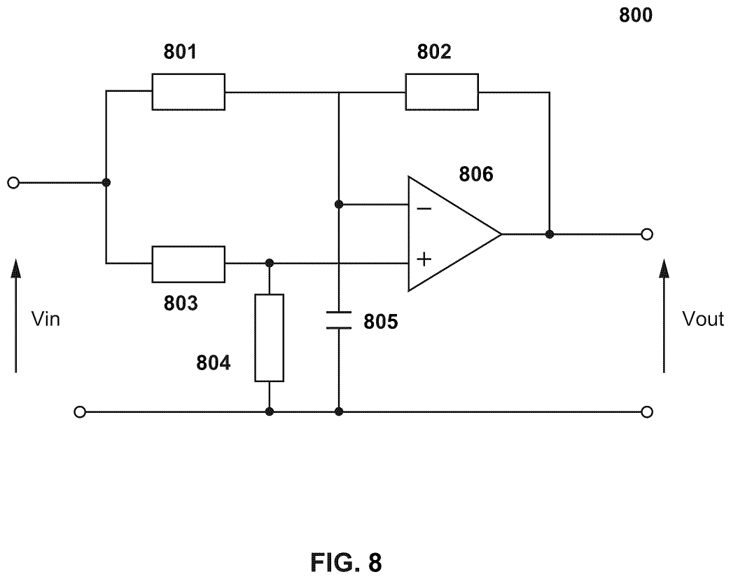

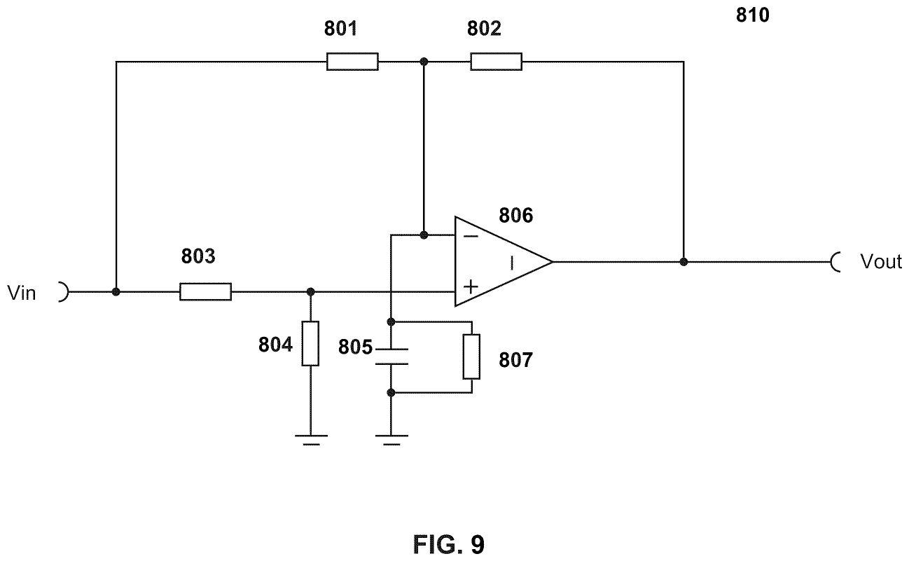

FIG. 8 illustrates a circuit of active non-inverting differentiator 800. The circuit includes operational amplifier 806, four resistors (801-804) and capacitor 805. However, this circuit is not ideal for applications in LIDAR systems with SiPM sensors. FIG. 9 illustrates a circuit of active non-inverting differentiator with pole compensation (810) according to some non-limiting embodiments of the present technology. Differentiator 810 includes operational amplifier 806, five resistors (801-804; 807) and capacitor 805 as shown in FIG. 9. Resistor 807 is installed in parallel to capacitor 805 to compensate for the poles. Disclosed active non-inverting differentiator with pole compensation 810 may allow to increase sensitivity of silicon photomultipliers in LIDAR receiver 122 by increasing the signal-to-noise ratio (SNR) on the receiving channels. An increase in the signal-to-noise ratio provides an increase in the effective range of LIDAR 100 and/or a reduction of the laser pulse energy. Active non-inverting differentiator with pole compensation 810 may provide for efficient SiPM sensor signal processing by electronic device 123.

The transfer function of the active non-inverting differentiator with pole compensation may be described by the equation:

$$H ( s ) = \frac{R 1 \cdot R 4 - R 2 \cdot R 3}{R 1 \cdot ( R 3 + R 4 )} + \frac{C 1 \cdot R 2 \cdot R 4 \cdot R 5 + R 2 \cdot R 4}{R 5 \cdot ( R 3 + R 4 )} ;$$

The input impedance of the circuit may be described by the equation:

$$Zin = \frac{R 1 \cdot ( R 3 + R 4 )}{R 1 + R 3} ;$$

The disclosed scheme implements pole compensation by placing resistor 807 in parallel with capacitor 805 to predominantly differentiate in the high frequency region and reduce differentiation in the low frequency region of the signal from LIDAR light detector 122. Differentiator 810 is active due to the presence of operational amplifier 806 in the circuit. This circuit also has an active input impedance. The active non-inverting differentiator with pole compensation may be combined with an input amplifier. The amplifier may be a part of electronic device 123 or controlling device 130.

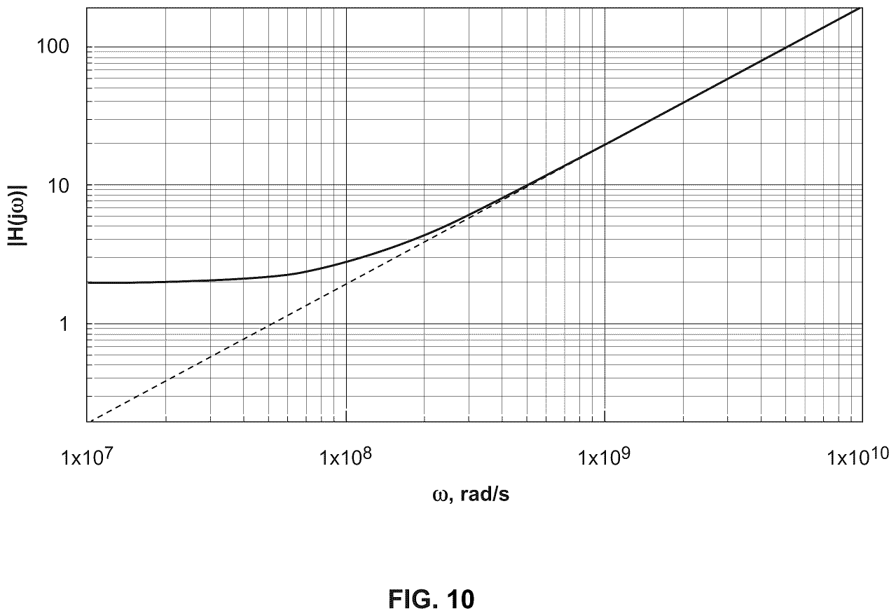

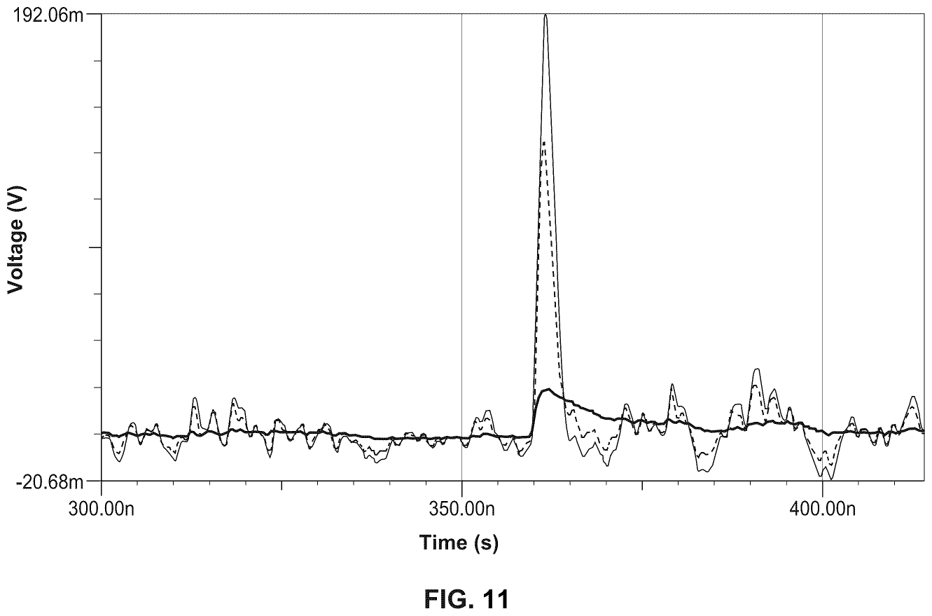

FIG. 10 illustrates the frequency response (the dashed line) of the active non-inverting differentiator 800. FIG. 10 also shows the frequency response (the solid line) of the active non-inverting differentiator with pole compensation 810. The disclosed circuit may allow to increase the SNR of a signal by differentiating the signal in the high frequency portion of the spectrum. The circuit also allows to control the initial “bend” of the graph by selecting values of the elements in the circuit. FIG. 11 illustrates an output signal (the solid line) of active non-inverting differentiator with pole compensation 810 together with an output signal (the dashed line) of active non-inverting differentiator without pole compensation 800 in a time domain. Both signals display similar level of noise. However, the signal, generated by differentiator 810 at its peak value is higher (10-20%) than the signal generated by differentiator 800. The fat solid line represents an output signal of a SiPM sensor.

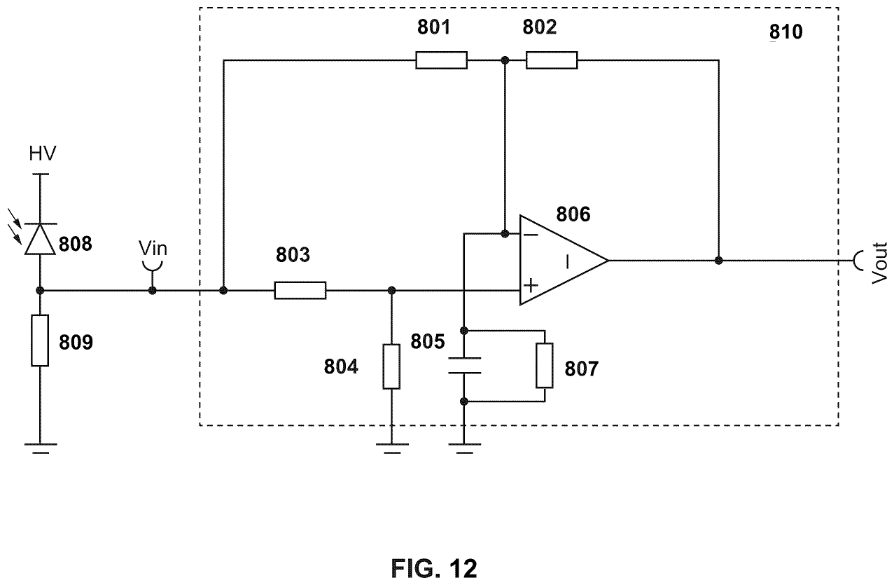

FIG. 12 illustrates a representative example of a circuit of LIDAR receiver 120 according to some non-limiting embodiments. Receiver 120 includes SiPM sensor 808 grounded through resistor 809. SiPM sensor 808 provides an input signal (Vin) to an input of active non-inverting differentiator 810. Structurally, sensor 808 and active non-inverting differentiator (with pole compensation) 810 may be located on the same printed circuit board of LIDAR receiver 120. The output signal (Vout) of differentiator 810 may be inputted to a next processing unit (for example, to an analog-to-digital converter (ADC), to a comparator, to an amplifier, etc.). In some embodiments of LIDAR receiver 120 with an active non-inverting differentiator, outputs of more than one SiPM sensors may be communicatively coupled to the input of the differentiator.

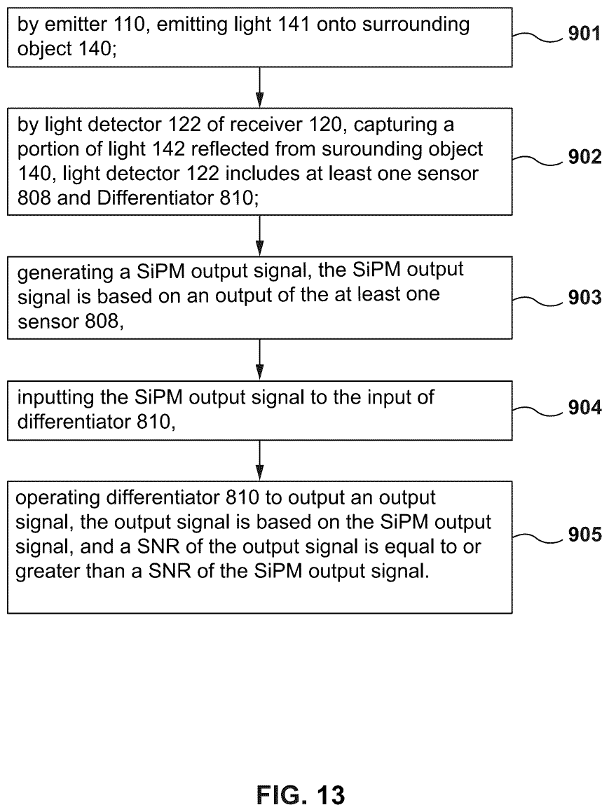

FIG. 13 illustrates a flowchart of a representative example of a method to operate LIDAR system 100. At action 901, by emitter 110 emitting light 141 onto surrounding object 140. At action 902, by light detector 122 of receiver 120 capturing a portion of light 142 reflected from surrounding object 140. Light detector 122 includes differentiator 810 and at least one SiPM sensor 808. At action 903, generating a SiPM output signal. The SiPM output signal is based on an output of the at least one sensor 808. At action 904, inputting the SiPM output signal to the input of differentiator 810. At action 905, operating differentiator 810 to output an output signal, the output signal is based on the SiPM output signal. A signal-to-nose ration (SNR) of the output signal is equal to or greater than a SNR of the SiPM output signal.

It should be noted that, in some embodiments of the present technology, the processor of controlling device 130 may comprise one or more processors and/or one or more microcontrollers configured to execute instructions and to carry out operations associated with the operation of LIDAR system 100. In various non-limiting embodiments of the present technology, the processor may be implemented as a single-chip, multiple chips and/or other electrical components including one or more integrated circuits and printed circuit boards. The processor may optionally contain a cache memory unit for temporary local storage of instructions, data, or additional computer information. By way of example, the processor may include one or more processors, or one or more controllers dedicated for certain processing tasks.

Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A light detection and ranging (LIDAR) system comprising:
an emitting unit, the emitting unit is configured to emit a light onto surrounding objects, and
a receiving unit, the receiving unit is configured to detect a portion of the light reflected from the surrounding objects,
the receiving unit includes:
at least one silicon photomultiplier (SiPM) sensor, and
a differentiator, an output of the at least one SiPM sensor communicatively coupled to an input of the differentiator,
the differentiator includes:
an operational amplifier,
a capacitor, a first and a second terminals of the capacitor are connected to an inverting input of the operational amplifier and a ground terminal of the differentiator respectively,
a first resistor, a first and a second terminals of the first resistor are connected to an input of the differentiator and the inverting input of the operational amplifier respectively,
a second resistor, a first and a second terminals of the second resistor are connected to the inverting input of the operational amplifier and an output of the operational amplifier respectively,
a third resistor, a first and a second terminals of the third resistor are connected to the input of the differentiator and a non-inverting input of the operational amplifier respectively,
a fourth resistor, a first and a second terminals of the fourth resistor are connected to the non-inverting input of the operational amplifier and the ground terminal of the differentiator respectively,
a fifth resistor, a first and a second terminals of the fifth resistor are connected to the inverting input of the operational amplifier and the ground terminal of the differentiator respectively, and
an output of the differentiator, the output of the differentiator is connected to the output of the operational amplifier,
wherein the differentiator is configured to output an output signal, the output signal is based at least in part on an input signal, a signal-to-noise ratio (SNR) of the output signal is equal to or greater than the SNR of an input signal, and
wherein the input signal is inputted to the input of the differentiator by the at least one SiPM sensor.

2. The system of claim 1, wherein the differentiator is configured to differentiate in a portion of a frequency domain of the input signal thereby increasing the SNR of the output signal in comparison to the SNR of the input signal.

3. The system of claim 1, wherein the differentiator is an active non-inverting differentiator.

4. The system of claim 1, wherein the differentiator is a differentiator with pole compensation.

5. The system of claim 3, wherein the differentiator is a differentiator with pole compensation.

6. The system of claim 1, wherein the input of the differentiator being an input with an active input impedance.

7. The system of claim 1, wherein the output of the differentiator is connected to an input of an amplifier or the differentiator is configured to operate as the amplifier.

8. A differentiator device of a light detection and ranging system comprising:
an operational amplifier;
a capacitor, a first and a second terminals of the capacitor are connected to an inverting input of the operational amplifier and a ground terminal of the differentiator device respectively;
a first resistor, a first and a second terminals of the first resistor are connected to an input of the differentiator device and the inverting input of the operational amplifier respectively;
a second resistor, a first and a second terminals of the second resistor are connected to the inverting input of the operational amplifier and an output of the operational amplifier respectively;
a third resistor, a first and a second terminals of the third resistor are connected to the input of the differentiator device and a non-inverting input of the operational amplifier respectively;
a fourth resistor, a first and a second terminals of the fourth resistor are connected to the non-inverting input of the operational amplifier and the ground terminal of the differentiator device respectively;
a fifth resistor, a first and a second terminals of the fifth resistor are connected to the inverting input of the operational amplifier and the ground terminal of the differentiator device respectively; and
an output of the differentiator device, the output of the differentiator device is connected to the output of the operational amplifier;
wherein the differentiator device is configured to output an output signal, the output signal is based at least in part on an input signal, and a signal-to-noise ratio (SNR) of the output signal is equal to or greater than the SNR of an input signal.

9. The differentiator device of claim 8,
wherein an output of at least one silicon photo multiplier (SiPM) sensor is communicatively coupled to an input of the differentiator device, and
wherein the input signal is inputted to the input of the differentiator device by the at least one SiPM sensor.

10. The differentiator device of claim 8, wherein the differentiator device is configured to differentiate in a portion of a frequency domain of the input signal thereby increasing the SNR of the output signal in comparison to the SNR of the input signal.

11. The differentiator device of claim 8 being an active non-inverting differentiator.

12. The differentiator device of claim 8 being a differentiator with pole compensation.

13. The differentiator device of claim 11 being a differentiator with pole compensation.

14. The differentiator device of claim 8, wherein the input of the differentiator device being an input with an active input impedance.

15. The differentiator device of claim 8, wherein the output of the differentiator device is connected to an input of an amplifier or the differentiator device is configured to operate as the amplifier.

16. A method to operate a light detection and ranging (LIDAR) system,
the LIDAR system comprises:
an emitting unit, and
a receiving unit,
the receiving unit includes:
at least one silicon photomultiplier (SiPM) sensor, and
a differentiator, an output of the at least one SiPM sensor communicatively coupled to an input of the differentiator,
an operational amplifier,
a capacitor,
a first resistor,
a second resistor,
a third resistor,
a fourth resistor, and
a fifth resistor,
wherein a first and a second terminals of the capacitor are connected to an inverting input of the operational amplifier and a ground terminal of the differentiator respectively,
wherein a first and a second terminals of the first resistor are connected to the input of the differentiator and the inverting input of the operational amplifier respectively,
wherein a first and a second terminals of the second resistor are connected to the inverting input of the operational amplifier and an output of the operational amplifier respectively,
wherein a first and a second terminals of the third resistor are connected to the input of the differentiator and a non-inverting input of the operational amplifier respectively,
wherein a first and a second terminals of the fourth resistor are connected to the non-inverting input of the operational amplifier and the ground terminal of the differentiator respectively,
wherein a first and a second terminals of the fifth resistor are connected to the inverting input of the operational amplifier and the ground terminal of the differentiator respectively, and
wherein the output of the operational amplifier being connected to an output of the differentiator,
the method comprising:
by the emitter unit:
emitting a light onto surrounding objects;
by the receiving unit:
capturing by the at least one SiPM sensor a portion of the light reflected from the surrounding objects;
generating a SiPM output signal, the SiPM output signal is based on an output of the at least one SiPM sensor;
inputting the SiPM output signal to the input of the differentiator; and
operating the differentiator to output an output signal;
wherein the output signal is based on the SiPM output signal, and
wherein a signal-to-noise ratio (SNR) of the output signal is equal to or greater than a SNR of the SiPM output signal.

17. The method of claim 16, wherein the differentiator is configured to differentiate in a portion of a frequency domain of the SiPM output signal thereby increasing the SNR of the output signal in comparison to the SNR of the SiPM output signal.

18. The method of claim 16, wherein the differentiator is a differentiator with pole compensation.

19. The method of claim 16, wherein the input of the differentiator being an input with an active input impedance.

20. The method of claim 16, wherein the output of the differentiator is connected to an input of an amplifier or the differentiator device is configured to operate as the amplifier.
